(19) United States
(12) Patent Application Publication
(10) Pub. No.: US 2009/0097431 A1
(43) Pub. Date: Apr. 16, 2009

(54) Automatic weather information downloading and displaying system

(75) Inventor: Tommy Chung, Kowloon Bay (HK)

Correspondence Address: EPSTEIN DRANGEL BAZERMAN & JAMES, LLP, 60 EAST 42ND STREET, SUITE 820, NEW YORK, NY, 10165, US

(73) Assignee: Profit MetalLtd.

(21) Appl. No.: 11/974,023

(22) Filed: Oct. 11, 2007

(51) Int. Cl. H04B 7/14; G09G 3/30; H04J 3/24

(52) U.S. Cl. 370/315; 345/76; 370/349

(57) ABSTRACT

The system for downloading and displaying information utilizes a computer with an Internet connection. The computer runs a program that causes it to access a weather information server with a pre-determined address, upon start-up and periodically thereafter, and to receive weather information for a given place or given places from the accessed server. A memory stores the received weather information. A controller selects successive portions of the stored weather information for transmission at predetermined time intervals. The selected portions of the stored weather information are wirelessly transmitted. The transmitted information portions are received at a remote location and checked for transmission errors. If no errors are detected, the information is displayed. In one embodiment, two-way communications between the transmission and receiver sections of the system are possible through the use of transceivers. In another, time information is also downloaded and displayed. A compensation algorithm compensates for signal processing and transmission delays.

### BACKGROUND OF THE INVENTION

1. Field of the Invention

The present invention relates to computerized systems for obtaining and remotely displaying information and more particularly to a method and apparatus for automatically downloading weather information from the Internet and for displaying the information at a remote location.

2. Description of Prior Art Including Information Disclosed Under 37 CFR 1.97 and 1.98

Currently, there are a number of Internet websites with servers that provide access to weather information to public users via the Internet. However, in order to obtain weather information from those web sites, the user has to turn on his/her personal computer, connect to the weather information web site and wait for the feedback from the weather information web site server. Some weather web sites can provide an option of periodically and automatically updating a weather information window on the user's computer monitor but the user still needs to keep his computer on and to sit in front of the computer monitor in order to view it. As far as is known, there is no system that includes an Internet connected personal computer capable of automatically downloading weather information from a weather information server and displaying the downloaded weather information on a device located remotely from the computer, such that the display device could be situated at a location most comfortable for the user to view. Such a system would permit the user to view the weather information any time he/she wishes, even after the personal computer has been turned off.

It is therefore, a prime object of the present invention to provide a system for automatically downloading and displaying weather information from the Internet.

It is another object of the present invention to provide a system for automatically downloading and displaying weather information from the Internet including an Internet connected computer programmed at start-up and periodically thereafter to connect to a weather information server and receive weather information therefrom.

It is another object of the present invention to provide a system for automatically downloading and displaying weather information from the Internet including a memory for storing the received weather information, segregating the stored information into portions, and sending the portions to a wireless transmitter sequentially, at predetermined time intervals.

It is another object of the present invention to provide a system for automatically downloading and displaying weather information from the Internet including a wireless transmitter for transmitting the weather information to a remotely located wireless receiver.

It is another object of the present invention to provide a system for automatically downloading and displaying weather information from the Internet wherein the transmitter may transmit the weather information to the receiver several times to maximize the probability of correct reception of the weather information by the receiver.

It is another object of the present invention to provide a system for automatically downloading and displaying weather information from the Internet including a display operably connected to the receiver for displaying the weather information.

It is another object of the present invention to provide a system for automatically downloading and displaying weather information from the Internet wherein stored weather information can be displayed even after the computer is turned off.

### BRIEF SUMMARY OF THE INVENTION

In general, those objects are achieved by the present invention which in one aspect relates to an apparatus for downloading and displaying information including a computer with an Internet connection. Means are provided for causing the computer to access a weather information server with a pre-determined address and to receive weather information for a given place or given places from the accessed server. Means are provided for storing the received weather information. Means are provided for selecting a first portion of the stored weather information for transmission. Means are provided for wirelessly transmitting the selected portion of the stored weather information. Means are provided for receiving the transmitted information portion. Means are provided for checking the received information portion for errors. Means are also provided for displaying the checked information, if no errors are detected.

The means for causing the computer to access a server with a pre-determined address includes means for causing the computer to access a server with a pre-determined address upon start-up and periodically thereafter.

The apparatus also includes means for selecting a second portion of the stored weather information for transmission.

The apparatus also includes means for selecting portions of the stored weather information for transmission until all of the stored weather information is selected.

The apparatus also includes means for causing the transmitting means to transmit the selected weather information portion more than one time.

The apparatus also includes means for transmitting the selected portions of the stored weather information at pre-determined time intervals.

The checking means includes means for checking the correctness of the received information based on parity bits, checksum, and/or cyclic redundancy check.

The transmitting means includes a transmitter using wireless transmission technology selected from a group comprising Radio Frequency, Bluetooth, Wi-Fi and ZigBee.

The displaying means may take the form of a LCD display, or on a LED display, or on a VFD (vacuum fluorescent) display or an OLED display.

The transmitting means may take the form of a transceiver. The receiving means may also take the form of a transceiver. The apparatus also includes means for causing the receiving means transceiver to transmit a message to the transmitting means transceiver indicating whether the received information contains errors.

The apparatus also includes means for actuating the apparatus to retransmit the selected portion to the receiving means transceiver, if the previously received information contains errors.

The apparatus also includes means for causing the computer to access a time server with a pre-determined address and to receive time information from the accessed server, means for storing the received time information, means for transmitting the received time information, means for receiving the transmitted time information and means for displaying the transmitted time information.

The apparatus also includes means for modifying the transmitted time information to compensate for the time interval between receipt and display of the time information.

In accordance with another aspect of the present invention, a method is provided for downloading and displaying information utilizing a computer with an Internet connection. The method begins by causing the computer to access a weather information server with a pre-determined address and to receive weather information for a given place or given places from the accessed server. The received weather information is stored. A first portion of the stored weather information is selected for transmission. The selected portion of the stored weather information is wirelessly transmitted. The transmitted information portion is received. The received information portion is checked for errors. If no errors are detected, the checked information is displayed.

The step of causing the computer to access a weather information server with a pre-determined address includes the step of causing the computer to access a weather information server with a pre-determined address upon start-up and periodically thereafter.

The method also includes the step of selecting a second portion of the stored weather information for transmission.

The method also includes the step of selecting portions of the stored weather information for transmission until all of the stored weather information is selected.

The method also includes the step of causing the transmitting means to transmit the selected weather information portion more than one time.

The method also includes the step of transmitting the selected portions of the stored weather information at pre-determined time intervals.

The step of checking includes the step of checking the correctness of the received information based on parity bits, checksum and/or cyclic redundancy check.

The step of transmitting includes the step of transmitting using wireless transmission technology selected from a group comprising Radio Frequency, Bluetooth, Wi-Fi and ZigBee.

The step of displaying includes the step of displaying on a LCD display, or on a LED display, or on a VFD display (vacuum fluorescent display) or on an OLED display.

The step of transmitting includes the step of transmitting using a transceiver. The step of receiving includes the step of receiving using a transceiver.

The method also includes the step of causing the receiving transceiver to transmit a message to the transmitting transceiver indicating whether the received information contains errors.

The method also includes the step of retransmitting the selected portion to the receiving transceiver, if the previously received information contains errors.

The method also includes the step of causing the computer to access a weather information server with a pre-determined address and to receive time information from the accessed server, the step of storing the received time information, the step of transmitting the received time information, the step of receiving the transmitted time information and the step of displaying the transmitted time information.

The method also includes the step of modifying the transmitted time information to compensate for the time interval between receipt and display of the time information.

### BRIEF DESCRIPTION OF THE SEVERAL VIEWS OF DRAWINGS

To these and to such other objects that may hereinafter appears, the present invention relates to a system for automatically downloading and displaying weather information from the Internet as described in detail in the following specification and recited in the annexed claims, taken together with the accompanying drawings, in which like numerals refer to like parts and in which:

FIG. 1 is a block diagram of a first preferred embodiment of the system of the present invention;

FIG. 2 is a flow chart of the operation of the section of the first preferred embodiment of the system of the present invention that obtains and transmits the weather information;

FIG. 3 is a flow chart of operation of the section of the first preferred embodiment of the system of the present invention that receives and displays the weather information;

FIG. 4 is a flow chart of the timing program that causes the computer access the weather information server to obtain the weather information;

FIG. 5 is a block diagram of a second preferred embodiment of the present invention;

FIG. 6 is a flow chart of the operation of the receiver section of the second preferred embodiment of the present invention;

FIG. 7 is a block diagram of a third preferred embodiment of the present invention; and

FIG. 8 is a flow chart of the operation of the time information compensation of the third preferred embodiment of the present invention.

### DETAILED DESCRIPTION OF THE INVENTION

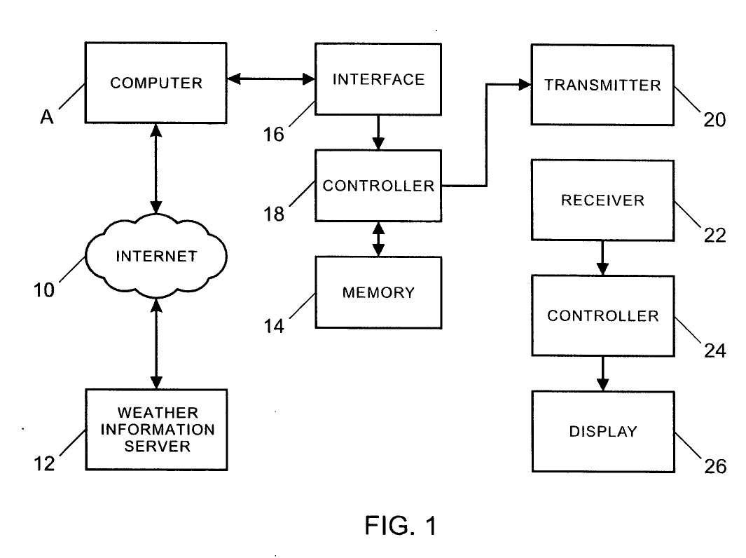

The components and operation of the basic system of the present invention is illustrated in FIGS. 1 through 4. As shown in FIG. 1, the weather information downloading and displaying system of the present invention includes a computer, generally designated A, which may be a personal computer or a laptop computer. Computer A is connected to the Internet 10 by any conventional means, such as cable or wireless means.

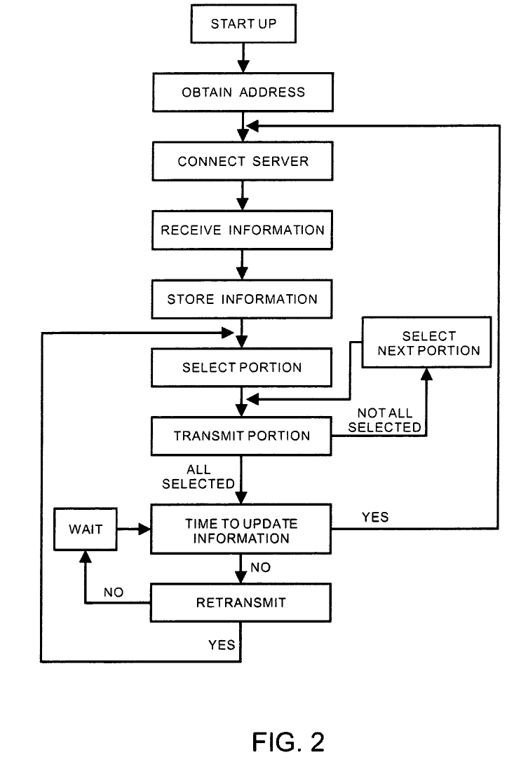

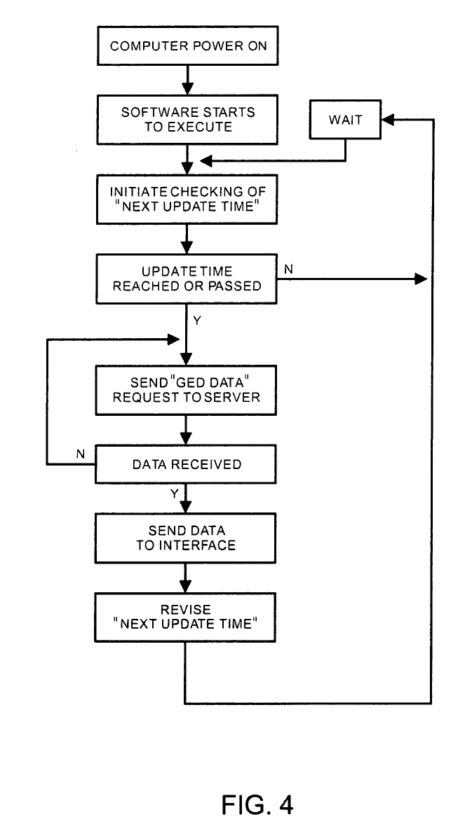

Computer A has a software program loaded therein. As illustrated in FIGS. 2 and 4, the program runs automatically each time the computer is turned on (start-up). Upon start-up, the program immediately activates a checking process on the “next update time” data stored in the computer memory or in controller 18. If the “next update time” has been reached or passed, the program will access the computer memory which has stored in it the URL or IP address of a server 12 that contains weather information for various geographic areas.

The software retrieves the address of the weather information server 12 from the computer memory and uses it to connect to the server 12 through the Internet 10. Once connected, a “get data” request is sent to server 12 to obtain pre-determined weather information (for example, current weather condition, current temperature, weather condition forecast, temperature forecast, etc.) for the geographic area of interest. That weather information from server 12 is then downloaded to computer A. A new time is also set to the “next update time”.

Once the weather information is received at computer A, it is sent to a memory 14, through an interface 16 and a controller 18. The received weather information is stored in memory 14.

The program will then periodically cause computer A to obtain updates of the desired weather information from server 12, which updated weather information is then downloaded to computer A and stored in memory 14.

As illustrated in FIG. 4, once running, the program keeps on checking the “next update time”. If the “next update time” is reached or passed, a “Get Data” request is sent to server 12. If the updated weather information is received from server 12, it is sent to interface 16 and through controller 18 to memory 14 to be saved. At the same time, a new time is set to the “next update time” and the program returns to the checking state.

When computer A is in the “power off” state, the software program cannot be executed. However, the most recent update of the weather information is retained in memory 14. Once the computer has been turned on again, the software program starts to execute and immediately accesses server 12, if a sufficiently long “power off” period has elapsed such that the “next update time” has been passed.

After receiving weather information from server 12, the software program sends the weather information to interface 16, which in turn passes the weather information along for transmission to controller 18, memory 14 and transmitter 20.

Controller 18 is a programmable microcontroller chip for general application. One example of such a chip is Model No. S3C72N8 available from Samsung Electronics.

As mentioned above, when the downloaded weather information is provided to interface 16, it is sent to controller 18 which causes it to be stored in memory 14. Controller 18 selects a first portion of the stored weather information (e.g. temperature) to form a message in a format compatible with the transmission technology used by transmitter 20. The controller then sends the message with the selected portion of the weather information to transmitter 20. After a period of time to allow for the complete transmission of the message by the transmitter 20, controller 18 selects a second portion of the stored weather information (e.g. humidity) and forms a message of the second portion of the weather information. That message is then sent to the transmitter. The controller repeats the information extraction and message formation/sending process, which may occur in one or more cycles, until all the stored weather information needed by display 24 and controller 22 has been extracted and transmitted.

The sequence of the weather information extraction depends on the size and the priority of the portions of the weather information being transmitted. With this system, all the stored weather information can still be transmitted, even when computer A has been turned off shortly after downloading the weather information, as all the received weather information has been stored in memory 14.

Transmitter 20 transmits the weather information using any conventional wireless technology, such as Radio Frequency, Bluetooth, Wi-Fi and ZigBee. To minimize the probability of data loss or corruption due to signal interference or other reasons during the transmission process, transmitter 20 may be set to transmit the same message two or more times at a pre-selected time interval, depending upon power availability and the weather information update interval.

A receiver 22, located remotely from transmitter 20, receives the wirelessly transmitted weather information from transmitter 20 and sends the received weather information to a controller 24.

Controller 24 is a programmable microcontroller chip for general application. For example, one such chip may be a Model No. S3C72N8 available from Samsung Electronics.

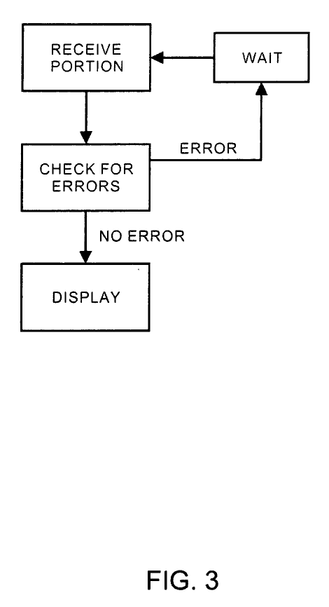

As illustrated in FIG. 3, controller 24 analyzes the content of the received weather information and determines if there are any transmission errors in the received information. It does this using conventional error checking methods, such as parity bits, checksum and cyclic redundancy check.

If the information passes the acceptance criteria, controller 24 causes a display 26 to display part or all of the weather information. Display 26 can be any conventional display, such as a display utilizing LCD, LED, VFD (vacuum fluorescent display) or OLED technology to display the weather information in numeric, text, graphical or any other appropriate format.

Otherwise, controller 24 causes display 26 to display weather information content based on the most recent weather information update that has been received, and/or to display some icons or messages on the display to notify the user that the update status of the weather information being displayed.

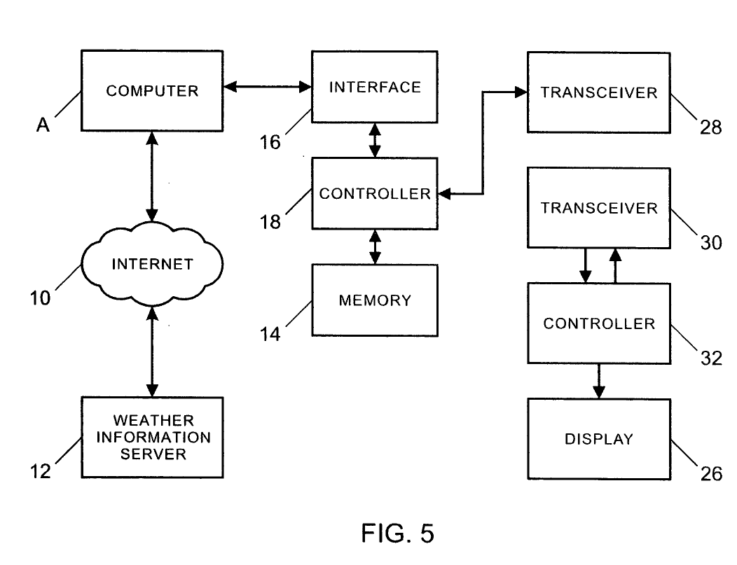

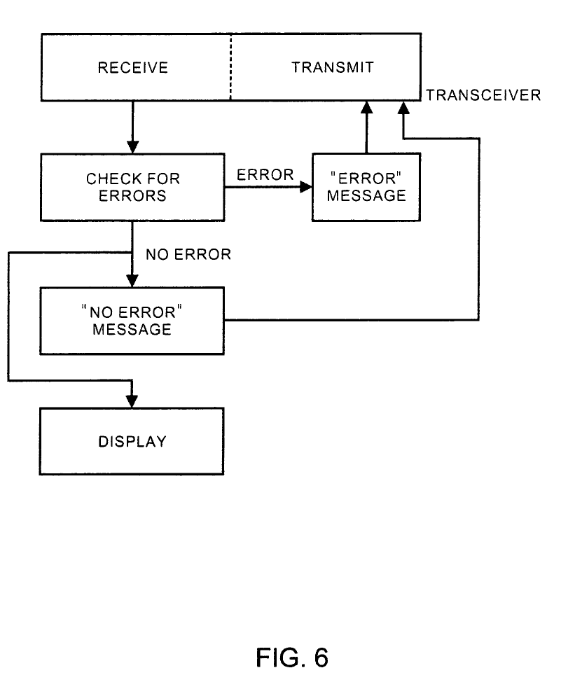

In a second preferred embodiment of the present invention, illustrated in FIGS. 5 and 6, all components and operations are the same as for the previously disclosed embodiment, except as follows. In the second preferred embodiment, wireless transmitter 20 is replaced by a wireless transceiver 28 and wireless receiver 22 is replaced by a wireless transceiver 30. Each transceiver 28, 30 can both transmit and receive information. Accordingly, in this embodiment, two-way communications are possible between the transmission section and the receiver section of the system.

In this case, controller 18 initially sends only a message with a first selected portion of the weather information via transceiver 28 to transceiver 30. Transceiver 30 passes the received weather information to a controller 32, which may be a chip similar to that used in controller 24. As shown in FIG. 6, controller 32 checks the validity of the received data, using the methods set forth previously. If the received data is determined to be valid, controller 32 causes the received information to be displayed by display 26 and causes transceiver 30 to send a “no error” message back to controller 18 via transceivers 28 and 30, causing controller 18 to select the next portion of the weather information, form a message of that information and transmit same.

On the other hand, if a transmission error has occurred, an “error” (data invalid) message is created by controller 32. The error message is sent through transceivers 30 and 28 to controller 18 as an alert that a transmission error has occurred. Controller 18 will then repeat the information retrieval, extraction, message creation and transmission process until a data valid message signal is received, or until a pre-defined maximum number of sending cycles has been reached without success.

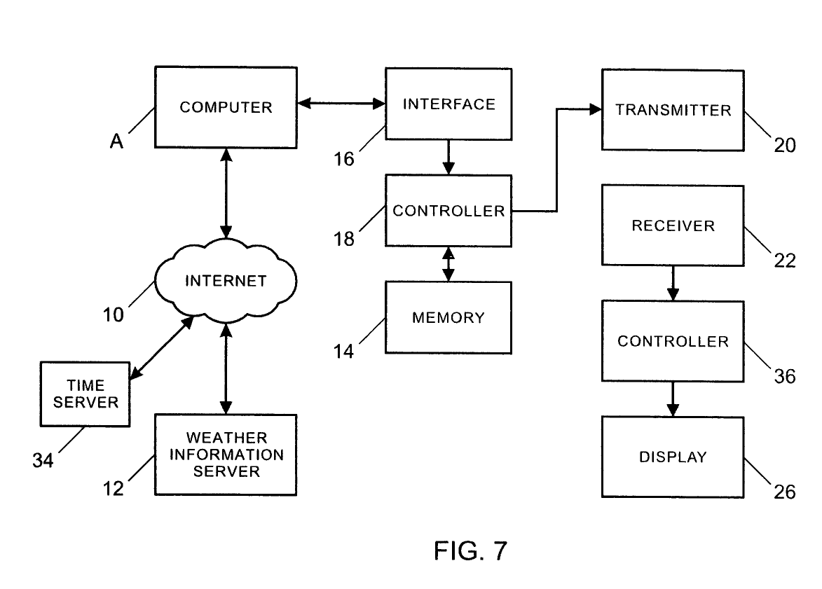

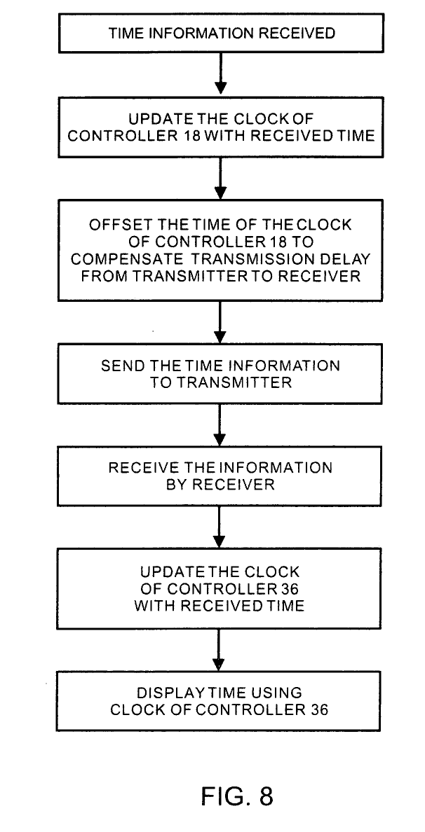

In a third preferred embodiment of the system of the present invention, as illustrated in FIGS. 7 and 8, time information is included as part of the displayed information. This is because accurate time information is also important to many people and it is a common practice to display both the weather and time information together. This embodiment of the invention can be utilized as a modification of either of the previously disclosed first and second preferred embodiments.

All of the components and operations of the systems described above will remain unchanged in this embodiment with the following exceptions. In this embodiment, as illustrated in FIG. 7, the memory of computer A will also include the address of a time server. The software program running on the computer will, upon user's request and/or periodically, retrieve the address of the time server, connect to that server and download the current time from that server.

The downloaded time information is transferred to the display device through the same path as the weather information. However, a compensation algorithm depending on the speed of the wireless transmission is needed to correct the time information in order to compensate for delays in the transmission process. In FIG. 8, the time information is modified for compensation by controller 18 before being sent to wireless transmitter 20. Alternatively, the time information sent to wireless transmitter 20 can be kept unchanged and the compensation can be then performed at controller 36 after receiving the time information.

It will now be appreciated that the present invention relates to a method and apparatus for downloading and displaying information using a computer with an Internet connection. The computer runs a program that causes it to access a weather information server with a pre-determined address, upon start-up and periodically thereafter, and to receive weather information for a given place or given places from the accessed server. A memory is provided for storing the received weather information. A controller selects successive portions of the stored weather information for transmission at predetermined time intervals. The selected portions of the stored weather information are wirelessly transmitted. The transmitted information portions are received at a remote location and checked for transmission errors. If no errors are detected, the information is displayed.

In one preferred embodiment of the present invention, two-way communications between the transmitter section of the system and the receiver section of the system are possible through the use of transceivers.

In another preferred embodiment, time information obtained from a time server is also displayed. A compensation algorithm is utilized to compensate for signal processing and transmission delays.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

I claim:

1. Apparatus for downloading and displaying information comprising a computer with an Internet connection, means for causing said computer to access a weather information server with a pre-determined address and to receive weather information for a given place or given places from said accessed server, means for storing said received weather information, means for selecting a first portion of said stored weather information for transmission, means for wirelessly transmitting said selected portion of said stored weather information, means for receiving said transmitted information portion, means for checking said received information portion for errors and means for displaying said checked information, if no errors are detected.

2. The apparatus of claim 1 wherein said means for causing said computer to access a server with a pre-determined address comprises means for causing said computer to access a server with a pre-determined address upon start-up and periodically thereafter.

3. The apparatus of claim 1 further comprising means for selecting a second portion of said stored weather information for transmission.

4. The apparatus of claim 1 further comprising means for selecting portions of said stored weather information for transmission until all of said stored weather information is selected.

5. The apparatus of claim 1 further comprising means for causing said transmitting means to transmit said selected weather information portion more than one time.

6. The apparatus of claim 4 further comprising means for transmitting said selected portions of said stored weather information at pre-determined time intervals.

7. The apparatus of claim 1 wherein said checking means comprises means for checking the correctness of the received information based on parity bits.

8. The apparatus of claim 1 wherein said checking means comprises means for checking the correctness of the received information based on checksum.

9. The apparatus of claim 1 wherein said checking means comprises means for checking the correctness of the received information based on cyclic redundancy check.

10. The apparatus of claim 1 wherein said transmitting means comprises a transmitter using wireless transmission technology selected from a group comprising Radio Frequency, Bluetooth, Wi-Fi and ZigBee.

11. The apparatus of claim 1 wherein said displaying means comprises a LCD display.

12. The apparatus of claim 1 wherein said displaying means comprises a LED display.

13. The apparatus of claim 1 wherein said displaying means comprises a VFD display (vacuum fluorescent display).

14. The apparatus of claim 1 wherein said displaying means comprises an OLED display.

15. The apparatus of claim 1 wherein said transmitting means comprises a transceiver.

16. The apparatus of claim 15 wherein said receiver means comprise a transceiver.

17. The apparatus of claim 16 further comprising means for causing said receiving means transceiver to transmit a message to said transmitting means transceiver indicating whether the received information contains errors.

18. The apparatus of claim 17 further comprising means for retransmitting the selected portion to said receiving means transceiver, if the previously received information contains errors.

19. The apparatus of claim 1 further comprising means for causing said computer to access a time server with a pre-determined address and to receive time information from said accessed server, means for storing said received time information, means for transmitting said received time information, means for receiving said transmitted time information and means for displaying said transmitted time information.

20. The apparatus of claim 19 further comprising means for modifying said transmitted time information to compensate for the time interval between receipt and display of the time information.

21. A method for downloading and displaying information utilizing a computer with an Internet connection, the method comprising the steps of:
causing the computer to access a server with a pre-determined address and to receive weather information for a given place or given places from said accessed server;
storing the received weather information;
selecting a first portion of the stored weather information for transmission;
wirelessly transmitting selected portion of the stored weather information;
receiving the transmitted information portion;
checking the received information portion for errors; and
displaying the checked information, if no errors are detected.

22. The method of claim 21 wherein the step of causing the computer to access a server with a pre-determined address comprises the step of causing the computer to access a server with a pre-determined address upon start-up and periodically thereafter.

23. The method of claim 21 further comprising the step of selecting a second portion of the stored weather information for transmission.

24. The method of claim 21 further comprising the step of selecting portions of the stored weather information for transmission until all of the stored weather information is selected.

25. The method of claim 21 further comprising the step of causing the transmitting means to transmit the selected weather information portion more than one time.

26. The method of claim 24 further comprising the step of transmitting the selected portions of the stored weather information at pre-determined time intervals.

27. The method of claim 21 wherein the step of checking comprises the step of checking the correctness of the received information based on parity bits.

28. The method of claim 21 wherein the step of checking comprises the step of checking the correctness of the received information based on checksum.

29. The method of claim 21 wherein the step of checking comprises the step of checking the correctness of the received information based on cyclic redundancy check.

30. The method of claim 21 wherein the step of transmitting comprises the step of transmitting using wireless transmission technology selected from a group comprising Radio Frequency, Bluetooth, Wi-Fi and ZigBee.

31. The method of claim 21 wherein the step of displaying comprises the step of displaying on a LCD display.

32. The method of claim 21 wherein the step of displaying comprises the step of displaying on a VFD display (vacuum fluorescent display).

33. The method of claim 21 wherein the step of displaying comprises the step of displaying on an OLED display.

34. The method of claim 21 wherein the step of transmitting comprises the step of transmitting using a transceiver.

35. The method of claim 34 wherein the step of receiving comprises the step of receiving using a transceiver.

36. The method of claim 35 further comprising the step of causing the receiving transceiver to transmit a message to the transmitting transceiver indicating whether the received information contains errors.

37. The method of claim 36 further comprising the step of retransmitting the selected portion to the receiving transceiver, if the previously received information contains errors.

38. The method of claim 37 further comprising the step of causing the computer to access a time server with a pre-determined address and receive time information from the accessed server, the step of storing the received time information, the step of transmitting the received time information, the step of receiving the transmitted time information and the step of displaying the transmitted time information.

39. The method of claim 38 further comprising the step of modifying the transmitted time information to compensate for the time interval between receipt and display of the time information.
